(19) United States
(12) Patent Application Publication
(10) Pub. No.: US 2015/0135539 A1
(43) Pub. Date: May 21, 2015

(54) FOOD PREPARATION TOOL

(71) Applicant: Columbia Insurance Company, Omaha, NE (US)

(72) Inventors: E. Mark Harris, McHenry, IL (US); Roland Sudmalis, Park Ridge, IL (US)

(73) Assignee: Colombia Insurance Company

(21) Appl. No.: 14/534,995

(22) Filed: Nov. 6, 2014

Related U.S. Application Data
(60) Provisional application No. 61/906,228, filed on Nov. 19, 2013.

(51) Int. Cl. A47J 25/00

(52) U.S. Cl. CPC A47J 25/00
USPC 30/122

(57) ABSTRACT

A food preparation tool includes a single loop of flexible material having a generally ovoid shape with a first end joined to a second end by two sides. The sides and ends form a continuous single loop having a continuous, uninterrupted outer surface and a continuous, uninterrupted inner surface. The tool further includes a. cutting surface formed on each end. The first end has a generally semicircular shape with a first radius and a first arc length. The second end has a generally semicircular shape with a second radius that is less than the first radius and a second arc length that is less than the first are length, when the tool is in a non-flexed state. A user may grip the tool at either end, causing the two sides adjacent the gripped end to flex and change the radius of that end.

### Cross-reference to Related Applications

This application claims priority to the U.S. Provisional Application No. 61/906,228 filed on Nov. 19, 2013, the contents of which are hereby incorporated herein by reference in its entirety.

### BACKGROUND OF THE INVENTION

This invention relates to a food preparation tool for slicing and scooping a food item, such as a mango or other soft fruits or vegetables.

### SUMMARY OF THE INVENTION

The food preparation tool disclosed herein provides a device that is both simple to use and easy to manufacture. It affords the user two different sizes for cutting, slicing, and/or scooping operations in a single loop, where both ends can be used for food preparation, and both ends have the flexibility to change the basic curvature for cutting, slicing, and/or scooping foods of different sizes. It can be used for cutting and removing the skin from foods such as mangoes, avocados and the like. It can also be used to scoop out or remove seeds, stems, cores, and other interior portions from foods such as cantaloupe, bell peppers, mushrooms, tomatoes, and the like. The lack of a separate handle or other external structure allows both ends to provide this cutting, scooping, and/or slicing feature, and provides for the necessary flexibility.

In one embodiment, a food preparation tool includes a single loop of flexible material having a general ovoid shape with a first end joined to a second end by two sides. Each side and the first end and the second end form a continuous single loop having a continuous, uninterrupted outer surface and a continuous, uninterrupted inner surface. The outer surface and the inner surface are connected by a first edge and a second edge opposite to the first edge. The food preparation tool further includes a first cutting surface is formed on the first end and a second cutting surface is formed on the second end. When the tool is in a non-flexed state, the first end has a generally semicircular shape having a first radius and a first arc length, and the second end has a generally semicircular shape having a second radius that is less than the first radius and a second arc length that is less than the first arc length. A user may grip the two sides adjacent the first end to flex the first end to change the first radius, or alternatively grip the two sides adjacent the second end to flex the second end to change the second radius.

In another embodiment, a food preparation tool includes a single loop of material having a general ovoid shape with a first end joined to a second end by two sides. Each side and the first end and the second end form a continuous single loop having a continuous, uninterrupted outer surface and a continuous, uninterrupted inner surface. The outer surface and the inner surface are connected by a first edge and a second edge opposite to the first edge. The first end has a generally semicircular shape having a first radius and a first arc length. The second end has a generally semicircular shape having a second radius that is less than the first radius and a second arc length that is less than the first arc length. At least one of the first end or the second end includes a first serrated surface formed on the first edge.

In another embodiment, a food preparation tool includes a single loop of flexible material having a general ovoid shape with a first end joined to a second end by two sides. Each side and the first end and the second end form a continuous single loop having a continuous, uninterrupted outer surface and a continuous, uninterrupted inner surface. The outer surface and the inner surface are connected by a first edge and a second edge opposite to the first edge. The food preparation tool further includes a first serrated surface formed on the first edge of the first end. The first edge is thinner at the first end than the first edge is at both of the sides. A user may grip the two sides adjacent the first end to flex the first end to change the radius of the first end, or alternatively grip the two sides adjacent the second end to flex the second end to change the radius of the second end.

A better understanding of the invention will be obtained from the following detailed descriptions and accompanying drawings, which set forth illustrative embodiments that are indicative of the various ways in which the principals of the invention may be employed.

### BRIEF DESCRIPTION OF THE DRAWINGS

FIG. 1 is a perspective view of one embodiment of a food preparation tool.

FIG. 2 is a top plan view of the food preparation tool of FIG. 1

FIG. 3 is a bottom plan view of the food preparation tool of FIG. 1.

FIG. 4 is a side elevational view of the food preparation tool of FIG. 1.

FIG. 5 is a first end view of the food preparation tool.

FIG. 6 is a second end view of the food preparation tool, opposite the first end.

FIGS. 7, 8, and 9 are perspective representational views of the food preparation tool in operation, showing different ways the tool may be manipulated by a user.

FIG. 10 is a perspective representational view of the food preparation tool showing a state of flex as pressure is applied to the unit.

FIG. 11 is a perspective representational view of the food preparation tool showing the unit in non-flexed position.

FIG. 12 is a perspective view of another embodiment of the food preparation tool.

### DETAILED DESCRIPTION OF THE DRAWINGS

The description that follows describes, illustrates and exemplifies one or more embodiments of the invention in accordance with its principles. This description is not provided to limit the invention to the embodiment(s) described herein, but rather to explain and teach the principles of the invention in order to enable one of ordinary skill in the art to understand these principles and, with that understanding, be able to apply them to practice not only the embodiment(s) described herein, but also any other embodiment that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers or serial numbers in cases where such labeling facilitates a more clear description. Additionally, the drawings set forth herein are not necessarily drawn to scale, and in some instances proportions may have been exaggerated to more clearly depict certain features. As stated above, this specification is intended to be taken as a whole and interpreted in accordance with the principles of the invention as taught herein and understood by one of ordinary skill in the art.

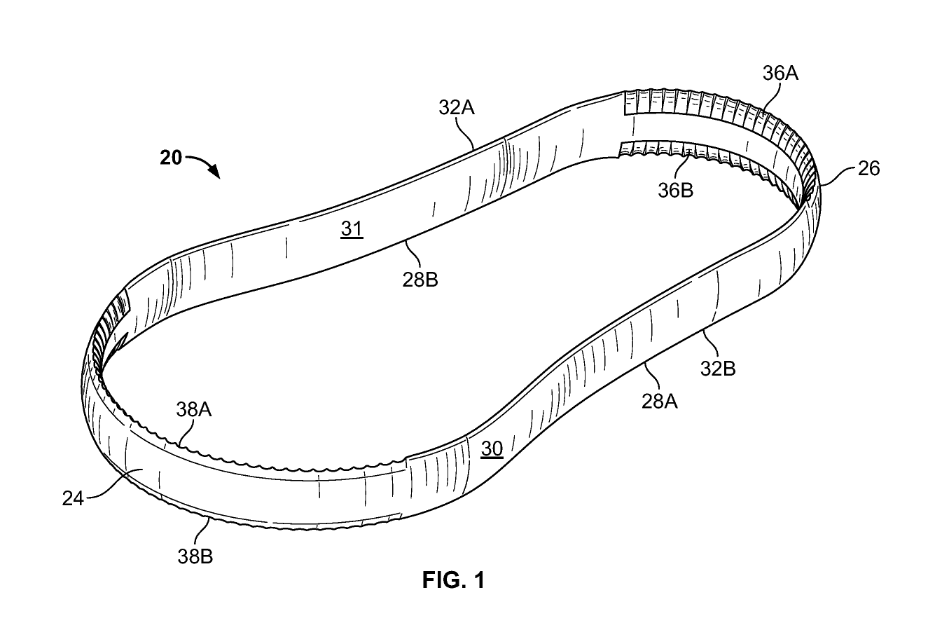

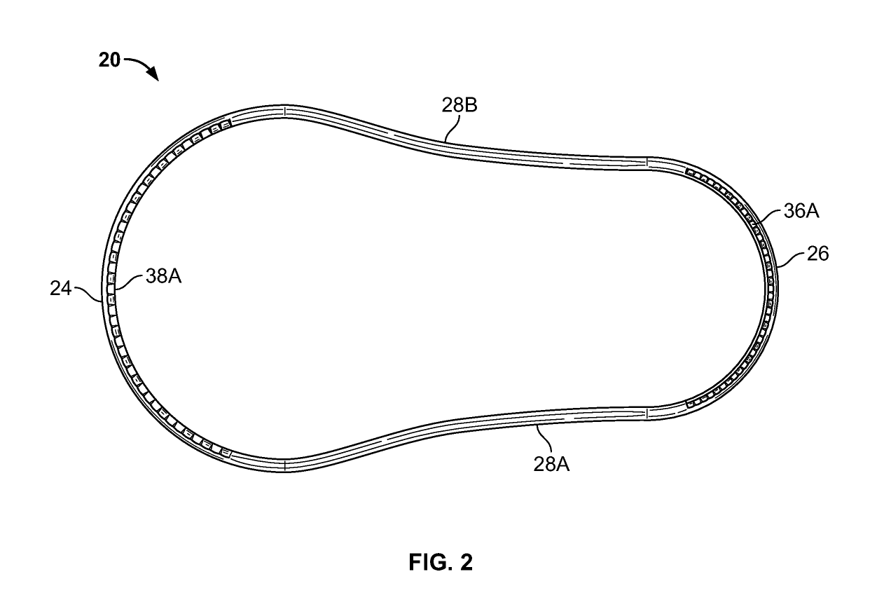

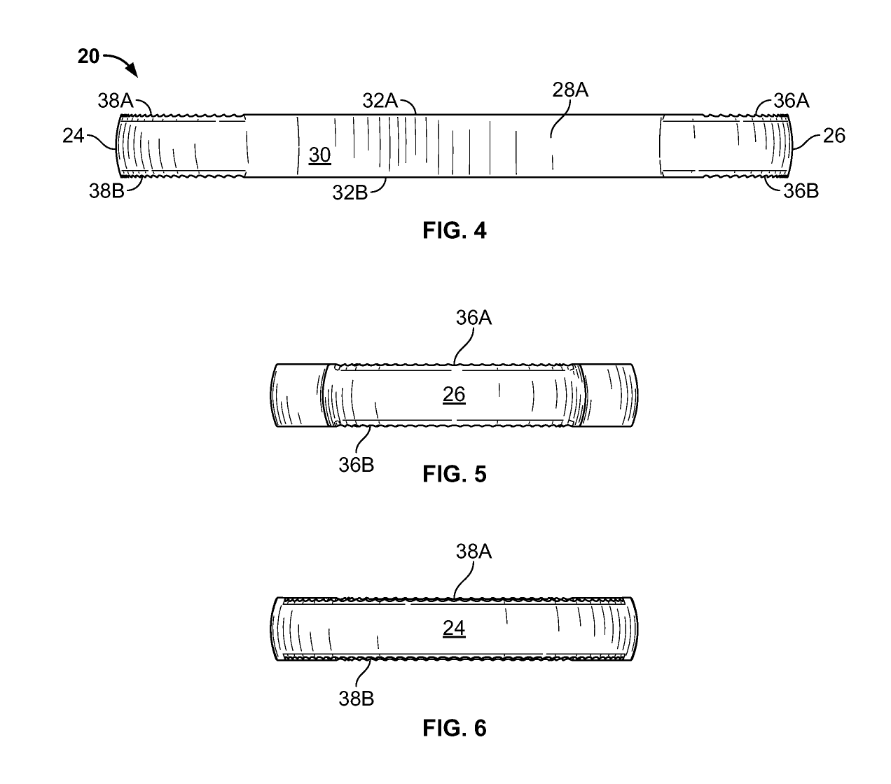

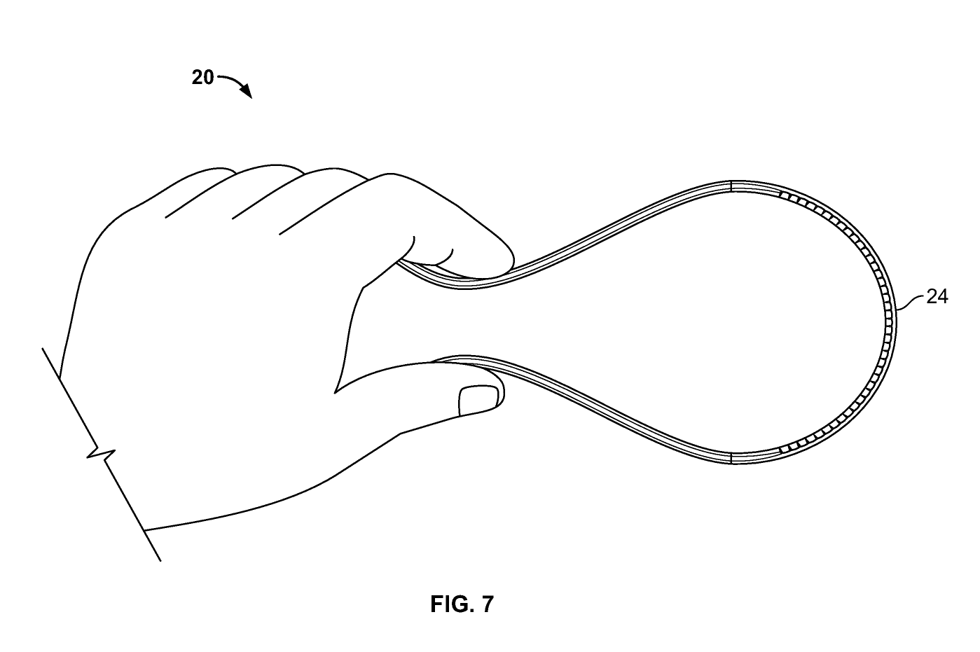

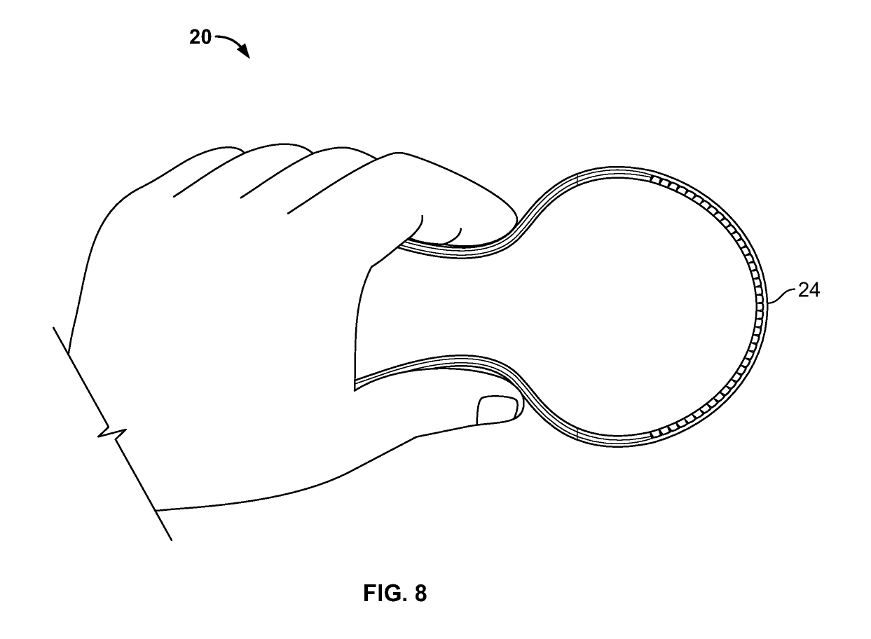

As shown in FIGS. 1-6, food preparation tool 20 is composed of a single loop of material, having a generally ovoid shape when in the non-flexed position, and an outer surface 30 and an inner surface 34 opposite thereto. A larger first end 24 and a smaller second end 26 are connected by a pair of sides 28A and 28B, and it is best described as generally ovoid in that the specific sizes of the ends are not critical, provided the sizes are within the usable range by a human hand, and the sides 28A, 28B may have a curvature. It could also be described as pear-shaped and the term “generally ovoid” should be read as inclusive thereof. The tool 20 is preferably composed of plastic, particularly 13% glass filled nylon.

Outer surface 30 of tool 20 is continuous and uninterrupted; i.e., it has no handle Or other extension to interrupt the surface. This lack of a handle or other protrusions creates a simpler design that is easier to manufacture and easier to use and store when tool 20 is not in use. Similarly, inner surface 31, formed opposite to outer surface 32, is also continuous and devoid of any interruptions, such as blades or other cutting structures. The space within, or adjacent to, the inner surface 31 is hollow or empty, to allow maximal manipulation, as discussed further below.

A pair of edges 32A and 32B are formed on opposite sides of tool 20 and are on both sides 28A and 28B as well as first end 24 and second end 26. Edges 32A and 32B are preferably thinner, resulting in a sharper cutting surface, at first end 24 and second end 26, than they are at sides 28A and 28B. It is preferred to have at least one serration on both ends, for many applications. As depicted in the preferred embodiment, second end 26 has separate serrated surfaces 36A and 36B formed on its portions of cutting edges 32A and 32B, while first end 24 has separate serrated surfaces 38A and 38B formed on its portions of cutting edges 32A and 32B.

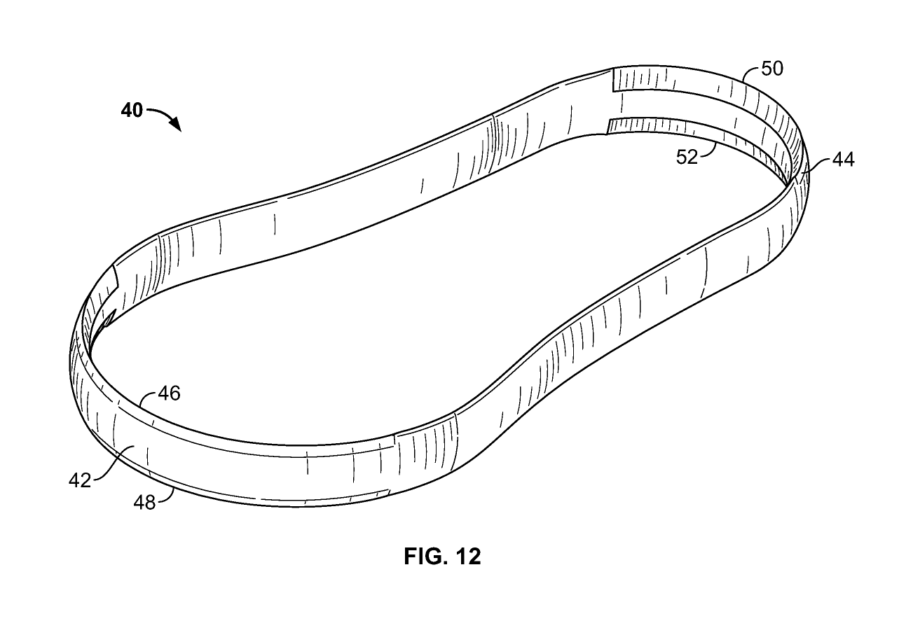

It will be understood, however, that some or all of these serrations could be removed, and replaced with a simply sharpened edge. For example, FIG. 12 shows a tool 40 with a first end 42 and a second end 44, each end having a pair of plain, sharpened edges. In particular, first end 42 includes sharpened cutting edges 46 and 48, and second end 44 includes sharpened cutting edges 50 and 52.

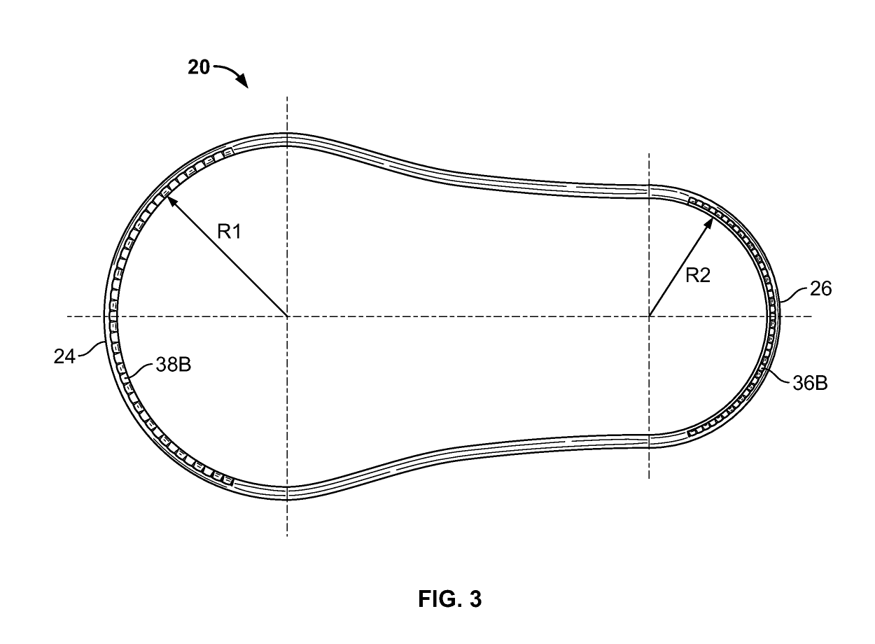

As shown most clearly in FIG. 3, first end 24 has radius R1 and second end 26 has radius R2. In the preferred embodiment, when the unit is in its non-flexed state, first end 24 has a radius R1 of 32.5 mm and an arc length of 85 mm over a 143° span, while second end 26 has a radius of 22.5 mm and an arc length of 51 mm over a 122° span. Different sizes and radii could be used depending on, among other things, the intended application and other preferences.

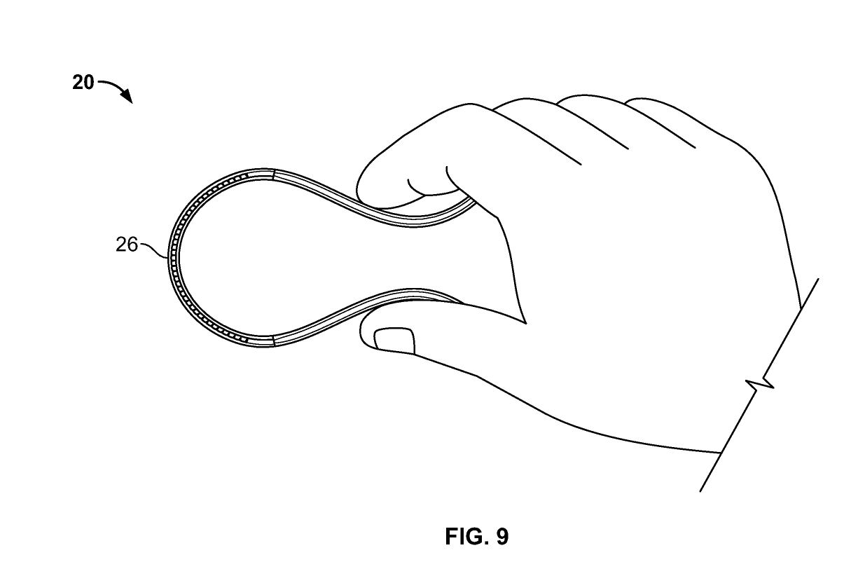

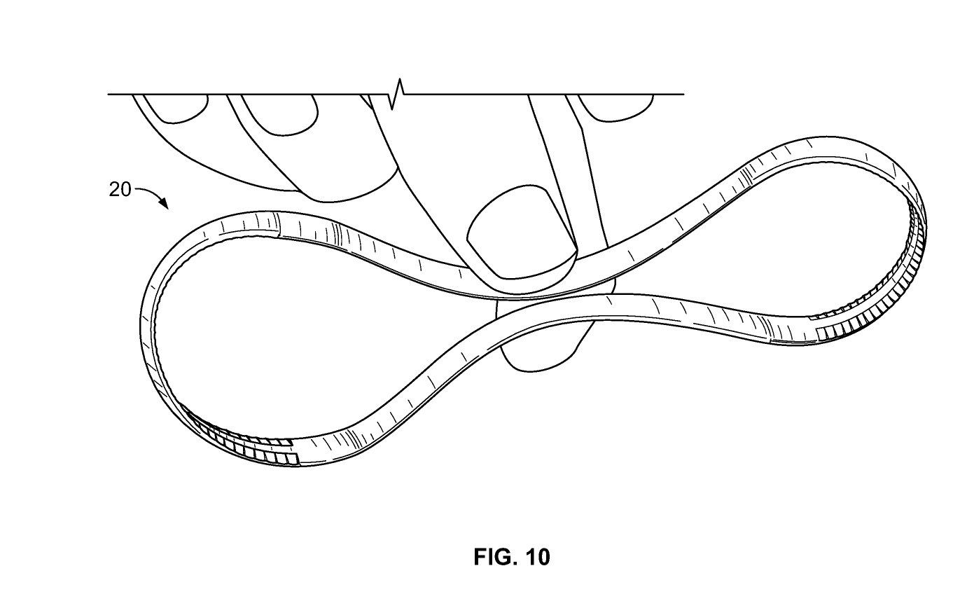

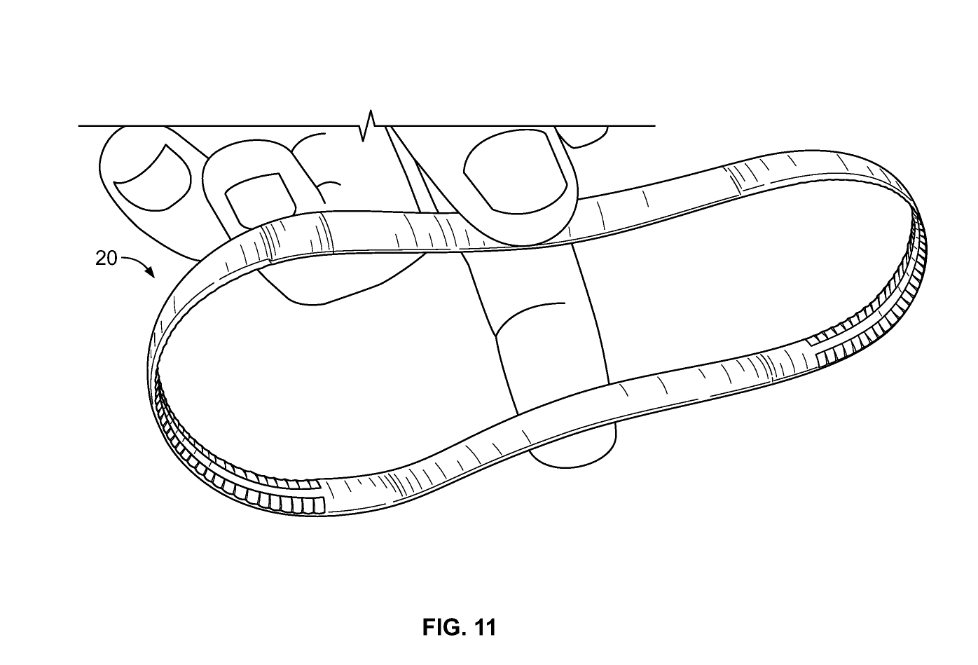

The uninterrupted outer surface 30 of tool 20 means that it may also be gripped by the user at any point along the outer surface 32, such as, e.g., at sides 28A and 28B. The flexible nature of the tool 20, along with the lack of any structure on the inner surface, means that the shape of tool 20 may be modified by the user, as shown in FIGS. 7-11, by squeezing on the outer surface 32 at various positions. This flexible nature is shown in FIGS. 7-10, which show the tool 20 in various states of flex, depending on how much pressure is applied to the sides 28A, 28B, and where along the sides 28A, 28B the pressure is applied by the user. As can be seen, the user is afforded great variability in the curvature of the cutting surfaces, as may be needed to cut or slice food products of different sizes. FIG. 11 depicts tool 20 ready for use in the non-flexed state.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the appended claims and any equivalent thereof.

We claim:

1. A food preparation tool, comprising:
a single loop of flexible material having a general ovoid shape with a first end joined to a second end by two sides, wherein each side and the first end and the second end form a continuous single loop having a continuous, uninterrupted outer surface and a continuous, uninterrupted inner surface, and the outer surface and the inner surface are connected by a first edge and a second edge opposite to the first edge; and
a first cutting surface formed on the first end, and a second cutting surface formed on the second end;
wherein, when the tool is in a non-flexed state, the first end has a generally semicircular shape having a first radius and a first arc length, and the second end has a generally semicircular shape having a second radius that is less than the first radius and a second arc length that is less than the first arc length, and wherein a user may grip the two sides adjacent the first end to flex the first end to change the first radius, or alternatively grip the two sides adjacent the second end to flex the second end to change the second radius.

2. The food preparation tool of claim 1, wherein the first radius is 32.5 millimeters, and the second radius is 22.5 millimeters, when the tool is in the non-flexed state.

3. The food preparation tool of claim 2, wherein the first arc length is 85 millimeters and the second arc length is 51 millimeters, when the tool is in the non-flexed state.

4. The food preparation tool of claim 1, wherein the tool is composed of glass filled nylon.

5. The food preparation tool of claim 1, wherein the first cutting surface comprises a first serrated edge formed on the first edge at the first end and the second cutting surface comprises a second serrated edge formed on the first edge at the second end.

6. The food preparation tool of claim 5, further comprising a third serrated edge formed on the first end and a fourth serrated edge formed on the second end.

7. The food preparation tool of claim 1, further comprising a third cutting surface formed on the second edge at the first end and a fourth cutting surface formed on the second edge at the second end.

8. The food preparation tool of claim 7, wherein the first cutting surface comprises a first serrated edge and the second cutting surface comprises a second serrated edge, the third cutting surface comprises a third serrated edge and the fourth cutting surface comprises a fourth serrated edge,

9. A food preparation tool, comprising:
a single loop of material having a general ovoid shape with a first end joined to a second end by two sides, wherein each side and the first end and the second end form a continuous single loop having a continuous, uninterrupted outer surface and a continuous, uninterrupted inner surface, and the outer surface and the inner surface are connected by a first edge and a second edge opposite to the first edge;
wherein the first end has a generally semicircular shape having a first radius and a first arc length, and the second end has a generally semicircular shape having a second radius that is less than the first radius and a second arc length that is less than the first arc length; and
wherein at least one of the first end or the second end includes a first serrated surface formed on the first edge.

10. The food preparation tool of claim 9, wherein a user may grip the two sides adjacent the first end to flex the first end to change the first radius, or alternatively grip the two sides adjacent the second end to flex the second end to change the second radius.

11. The food preparation tool of claim 9, further comprising a second serrated surface formed on the second edge of either the first end or the second end.

12. The food preparation tool of claim 9, wherein the first edge is thinner at the first end than the first edge is at both of the sides.

13. The food preparation tool of claim 12, wherein the second edge is thinner at the first end than the second edge is at both of the sides.

14. The food preparation tool of claim 13, wherein the first edge is thinner at the second end than the first edge is at both of the sides, and wherein the second edge is thinner at the second end than the second edge is at both of the sides.

15. A food preparation tool, comprising:
a single loop of flexible material having a general ovoid shape with a first end joined to a second end by two sides, wherein each side and the first end and the second end form a continuous single loop having a continuous, uninterrupted outer surface and a continuous, uninterrupted inner surface, and the outer surface and the inner surface are connected by a first edge and a second edge opposite to the first edge; and
a first serrated surface formed on the first edge of the first end, wherein the first edge is thinner at the first end than the first edge is at both of the sides, and wherein a user may grip the two sides adjacent the first end to flex the first end to change the radius of the first end, or alternatively grip the two sides adjacent the second end to flex the second end to change the radius of the second end.

16. The food preparation tool of claim 15, further comprising a second serrated surface formed on one of the edges of the second end.

17. The food preparation tool of claim 16, further comprising a third serrated edge formed on the first end and a fourth serrated edge formed on the second end.

18. The food preparation tool of claim 15, wherein the first edge is thinner at the second end than the first edge is at both of the sides, and wherein the second edge is thinner at the second end than the second edge is at both of the sides.

19. The food preparation tool of claim 15, wherein the first edge is thinner at the first end than the first edge is at both of the sides.

20. The food preparation tool of claim 19, wherein the second edge is thinner at the first end than the second edge is at both of the sides.
